(19) United States
(12) Patent Application Publication
(10) Pub. No.: US 2023/0107441 A1
(43) Pub. Date: Apr. 6, 2023

(54) POWER TRANSACTION SYSTEM

(71) Applicant: TOYOTA JIDOSHA KABUSHIKI KAISHA, Toyota-shi (JP)

(72) Inventors: Kazutaka KIMURA, Mishima-shi (JP); Kazuki OBATA, Susono-shi (JP); Satoshi KIKUCHI, Hadano-shi (JP); Yuki KUDO, Susono-shi (JP); Hiromitsu KIGURE, Ashigarakami-gun (JP); Yuta MANIWA, Susono-shi (JP)

(73) Assignee: TOYOTA JIDOSHA KABUSHIKI KAISHA, Toyota-shi (JP)

(21) Appl. No.: 17/943,333

(22) Filed: Sep. 13, 2022

(30) Foreign Application Priority Data
Oct. 4, 2021 (JP) 2021-163488

(51) Int. Cl. G06Q 30/00; G06Q 50/06

(52) U.S. Cl. CPC G06Q 30/018; G06Q 50/06

(57) ABSTRACT

A power transaction market includes a first individual market and a second individual market. The first individual market is configured to implement transactions of electric power between power resources in a normal state of the power system. The second individual market is configured to implement transactions of electric power between the power resources in an emergency state in which supply of electric power from the power system is stopped. A management device that manages transactions of electric power between the power resources is configured to impose a penalty on a participant who does not implement a contract for a transaction of electric power in each of the first and second individual markets. The management device is configured to set the penalty in the second individual market to a higher value than the penalty in the first individual market.

### CROSS-REFERENCE TO RELATED APPLICATION

This application claims priority to Japanese Patent Application No. 2021-163488 filed on Oct. 4, 2021, incorporated herein by reference in its entirety.

### BACKGROUND

### 1. Technical Field

The present disclosure relates to a power transaction system.

### 2. Description of Related Art

A power transaction platform in which members can sell and purchase electric power including photovoltaic electric power is disclosed in Japanese Unexamined Patent Application Publication No. 2020-9334 (JP 2020-9334 A). In JP 2020-9334 A, computers of the members are equally connected via a computer network. An amount of sold electric power or an amount of purchased electric power which is sold or purchased via a power network is verified and approved based on blockchain technology, is then collected as one block in a ledger which is provided to all the members, and is managed based on blockchain technology.

### SUMMARY

In the power transaction platform, each member includes a photovoltaic system and a storage battery and can perform a transaction of surplus electric power stored in the storage battery with another member via a computer network.

However, when a power transaction for which a contract has been made between members is not implemented, there is concern that a member may have difficulty procuring the electric power corresponding to a demand which has been planned beforehand. There is a possibility of a balance between supply and demand of electric power in a power network transmitting and distributing electric power being affected. Accordingly, there is demand for a structure capable of prompting participants, who participate in a power transaction in the power transaction platform, to reliably implement a contract and to reliably prepare a power tender plan.

The present disclosure provides a peer-to-peer (P2P) power transaction system that can prompt participants to reliably implement contracts by imposing an appropriate penalty on a participant who does not implement a contract in a power transaction.

According to the present disclosure, there is provided a power transaction system that implements a transaction of electric power in a power distribution network connected to a power system. A plurality of power resources is connected to the power distribution network. Each of the plurality of power resources is configured to perform at least one of transmitting and receiving electric power to and from another power resource via the power distribution network and directly transmitting and receiving electric power to and from another power resource via a charging/discharging facility owned by the corresponding power resource. The power transaction system includes a power transaction market in which a peer-to-peer (P2P) transaction of electric power is implemented and a management device configured to manage transactions of electric power between the plurality of power resources. The power transaction market includes a first individual market and a second individual market. The first individual market is configured to implement transactions of electric power between the plurality of power resources in a normal state of the power system. The second individual market is configured to implement transactions of electric power between the plurality of power resources in an emergency state in which supply of electric power from the power system is stopped. The management device is configured to impose a penalty on a participant who does not implement a contract for a transaction of electric power in each of the first and second individual markets. The management device is configured to set the penalty in the second individual market to a higher value than the penalty in the first individual market.

With this configuration, in each of the normal state and the emergency state of the power system, an appropriate penalty set based on a point of view of maintaining a balance between supply and demand of electric power in the power distribution network can be imposed on a participant who does not implement a contract for a transaction of electric power. Accordingly, since a participant can be prompted to reliably implement a contract, it is possible to reduce an influence on the balance between supply and demand of electric power in the power distribution network.

The power transaction market may be configured to transition from the first individual market to the second individual market and to notify the participant that the penalty has changed with transitioning to the second individual market when occurrence of a power failure in the power system has been detected.

With this configuration, a participant who plans to implement a transaction of electric power in the second individual market in the emergency state of the power system can be prompted to reliably implement a contract and to prepare a tender plan with a high implementation probability.

The management device may be configured to calculate an attainment level based on transaction results of the participant in each of the first and second individual markets and to increase the penalty imposed on the participant as the calculated attainment level decreases. The management device may be configured to set the penalty in the second individual market for an attainment level to a higher value than the penalty in the first individual market for the same attainment level.

With this configuration, since the penalty is set according to an attainment level based on transaction results of a participant, it is possible to impose an appropriate penalty on the participant. In the emergency state of the power system, since a higher penalty than that in the normal state of the power system is imposed, the participant can be prompted to reliably implement a contract.

The management device may be configured to calculate the attainment level of the participant based on an amount of electric power to be traded by the participant according to the contract and an amount of electric power traded by the participant.

With this configuration, it is possible to accurately evaluate an attainment level of a participant based on a result value of an amount of electric power traded by the participant. Accordingly, it is possible to impose an appropriate penalty on the participant.

The management device may be configured to calculate the attainment level of the participant based on a market price of an amount of electric power traded by the participant.

With this configuration, an urgency of demand in the power resources is reflected in the market price of the amount of traded electric power. Accordingly, it is determined that a higher market price of an amount of electric power corresponds to an increase in demand of electric power in the power resources, and the attainment level of a participant increases. As a result, it is possible to accurately evaluate an attainment level of a participant.

The management device may be configured to calculate the attainment level of the participant based on a proportion of regenerable electric power in an amount of electric power traded by the participant.

With this configuration, it is determined that a degree of contribution to stable supply of energy and a decrease in environmental load becomes higher as the proportion of regenerable electric power in an amount of electric power traded by a participant becomes higher, and the attainment level of a participant increases. As a result, it is possible to accurately evaluate an attainment level of a participant.

The management device may be configured to set the penalty in a transaction of electric power transmitted and received via the power distribution network in each of the first and second individual markets to a higher value than the penalty in a transaction of electric power transmitted and received via the charging/discharging facility.

When electric power is traded via the power distribution network, an influence of nonfulfillment of a contract on a balance between supply and demand of electric power in the power distribution network is predicted to be greater than that when electric power is directly traded via charging/discharging facilities of the power resources. Accordingly, by setting the penalty to a higher value, it is possible to prompt a participant to reliably implement a contract.

The management device may be configured to increase the penalty imposed on a seller who does not implement a contract as an urgency level for electric power for a purchaser increases in each of the first and second individual market. The management device may be configured to set the penalty in the second individual market for an urgency level to a higher value than the penalty in the first individual market for the same urgency level.

With this configuration, when the urgency level of demand for electric power in the power resources is high, it is possible to request a partner of a power transaction to reliably implement a contract by setting the penalty to a higher value. In the emergency state of the power system, supply of electric power from the power system is stopped and thus a necessary amount of electric power needs to be supplied from only other power resources. Accordingly, by setting the penalty to a higher value as the urgency level of electric power becomes higher, it is possible to reliably achieve supply of electric power.

The management device may be configured to output a request for transitioning from the first individual market to the second individual market in the power transaction market via a communication network when occurrence of a power failure in the power system has been detected. The power transaction market may be configured to invalidate the first individual market and to validate the second individual market in response to the request from the management device. The management device may be configured to open a third individual market having the same function as the second individual market independently from the power transaction market and to manage transactions of electric power in the third individual market when communication with the power transaction market has not been established.

With this configuration, in the emergency state of the power system, it is possible to prevent a transaction of electric power between the power resources from becoming impossible due to a communication failure between the power transaction market and the management device.

The management device may include a power adjustment resource connected to the power distribution network. The management device may be configured to control the power adjustment resource such that electric power is supplied to the power distribution network when an amount of electric power supplied to the power distribution network is insufficient in the emergency state of the power system.

With this configuration, in the emergency state of the power system, it is possible to curb balance loss between supply and demand of electric power in the power distribution network.

The management device may be configured to calculate an index indicating a credit rating level in a transaction of electric power of the participant in each of the first and second individual markets and to generate participant information using the calculated index. The management device may be configured to decrease the index as the penalty imposed on the participant increases.

With this configuration, a power resource can implement a contract with reference to the credit rating level of another power resource in addition to tender conditions of the power resource. Accordingly, it is possible to promote transactions of electric power between the power resources with high credit rating levels and thus to reduce nonfulfillment of contracts.

According to another aspect of the present disclosure, there is provided a power transaction system that implements a transaction of electric power in a power distribution network connected to a power system. A plurality of power resources is connected to the power distribution network. Each of the plurality of power resources is configured to perform at least one of transmitting and receiving electric power to and from another power resource via the power distribution network and directly transmitting and receiving electric power to and from another power resource via a charging/discharging facility owned by the corresponding power resource. The power transaction system includes a power transaction market in which a peer-to-peer (P2P) transaction of electric power is implemented and a management device configured to manage transactions of electric power between the plurality of power resources. The management device is configured to impose a penalty on a participant who does not implement a contract for a transaction of electric power in the power transaction market and to calculate an index indicating a credit rating level in a transaction of electric power of the participant based on the penalty imposed on the participant for each participant. The management device is configured to decrease the index as the penalty imposed on the participant increases.

With this configuration, since a credit rating level of a participant in a transaction of electric power is evaluated based on penalties imposed on participants who do not implement a contract, a power resource can implement a contract with reference to the credit rating level of another power resource in addition to tender conditions of the power resource. Accordingly, it is possible to promote transactions of electric power between the power resources with high credit rating levels and thus to reduce nonfulfillment of contracts.

According to the present disclosure, it is possible to prompt participants to reliably implement contracts by imposing an appropriate penalty on a participant who does not implement a contract in a power transaction in a P2P power transaction system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a power transmission and distribution system;

FIG. 2 is a diagram schematically illustrating a configuration of a power transaction system according to an embodiment;

FIG. 3 is a diagram schematically illustrating a configuration of the power transaction system according to the embodiment;

FIG. 4 is a diagram schematically illustrating the entire configuration of the power transaction system according to the embodiment;

FIG. 5 is a flowchart illustrating a routine of transitioning from a normal market to an emergency market;

FIG. 6 is a flowchart illustrating a routine of transitioning from a normal market to an emergency market;

FIG. 7 is a diagram illustrating an example of a method of calculating an attainment level;

FIG. 8 is a diagram schematically illustrating a relationship between an attainment level and a penalty;

FIG. 9 is a diagram schematically illustrating a relationship between a power urgency level of a purchaser and a penalty;

FIG. 10 is a diagram schematically illustrating a relationship between a credit rating score of a power resource and a penalty; and

FIG. 11 is a diagram illustrating an example of participant information.

### DETAILED DESCRIPTION OF EMBODIMENTS

Hereinafter, an embodiment of the present disclosure will be described in detail with reference to the accompanying drawings. The same or corresponding elements in the drawings will be referred to by the same reference signs and description thereof will not be repeated.

Configuration of Power Transmission and Distribution System

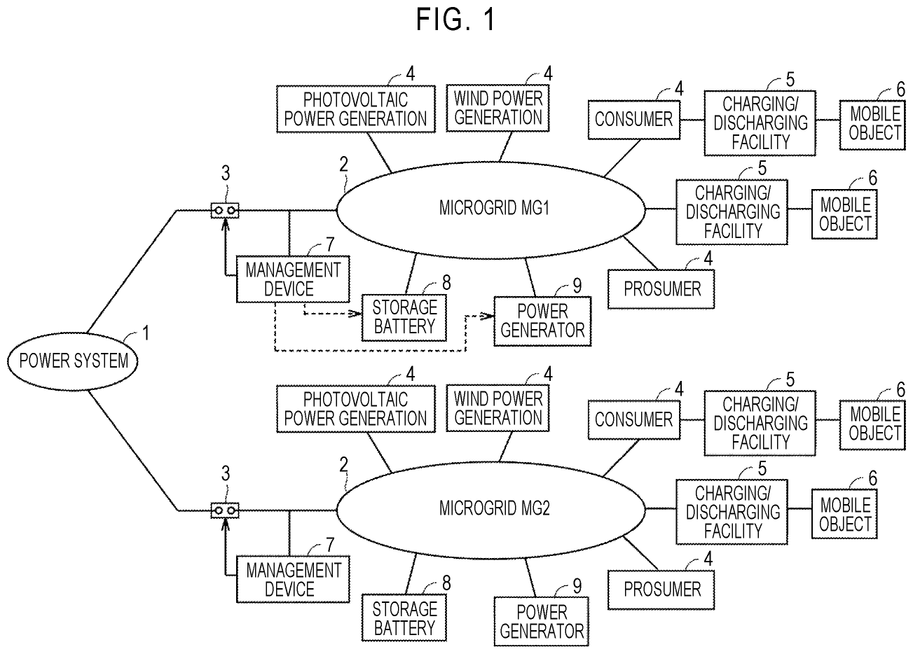

FIG. 1 is a diagram schematically illustrating an example of a configuration of a power transmission and distribution system to which a power transaction system according to an embodiment is applied.

Referring to FIG. 1, a microgrid MG includes a power distribution network 2 connected to a power system 1 and a plurality of power resources 4 connected to the power distribution network 2. In the microgrid MG, a plurality of power resources 4 is connected as one group to a power system. In FIG. 1, an example of a configuration in which two microgrids MG1 and MG2 are connected to the power system 1 via switches 3 is illustrated. In the following description, when the microgrids MG1 and MG2 are generically mentioned, they are referred to as a “microgrid MG.”

The power resources 4 include a distributed power supply and a consumer. A distributed power supply is a small power generation facility, and examples thereof include a power generation facility using fossil fuels such as a gas engine and a gas turbine, a power generation facility using regenerable energy such as photovoltaic power generation, wind power generation, and biomass power generation, a power generation facility using hydrogen such as a fuel cell, and a power storage device such as a storage battery. The storage battery may include a storage battery mounted in a mobile object 6. The mobile object 6 includes a storage battery in which charging from the outside and discharging to the outside are possible. Examples of the mobile object include an electric vehicle, a hybrid vehicle, a plug-in hybrid vehicle, or an automated-driving vehicle that can transport objects in an unmanned manner.

The power resources 4 additionally include prosumers. A prosumer is a consumer including a power generation facility and a power storage device that stores electric power generated by the power generation facility and is configured to store electric power generated by the power generation facility in the power storage device and to supply surplus electric power to another power resource.

In FIG. 1, charging-discharging facilities 5 are connected to the power distribution network 2, and a storage battery of a mobile object 6 can be charged or discharged by connecting the mobile object 6 to the charging/discharging facility 5. Since a charging/discharging facility 5 can also be provided in a facility of a power resource 4, transmission and reception of electric power between the mobile object 6 and the power resource 4 may be performed via the power distribution network 2 or may be performed directly via the charging/discharging facility 5 provided in the power resource 4. Accordingly, the mobile object 6 can be used as a power resource.

A management device 7 that adjusts a balance between supply and demand of electric power in the microgrid MG is provided in the microgrid MG. The management device 7 controls outputs of the distributed power supplies such that demand and supply of electric power are balanced. By balancing demand and supply of electric power, it is possible to curb fluctuation in voltage and frequency of electric power which is transmitted via the power distribution network 2. In the example illustrated in FIG. 1, the management device 7 of the microgrid MG1 includes a storage battery 8 and a power generator 9 such as a gas engine as a distributed power supply that can control an amount of electric power supplied to the power distribution network 2. The storage battery 8 and the power generator 9 correspond to an example of a “power adjustment resource.”

The microgrid MG can be connected to the power system 1 or another microgrid MG in a normal state of the power system 1. The microgrid MG can also operate independently from the power system 1. For example, in an emergency state in which supply of electric power from the power system 1 is stopped due to disasters or the like, the switch 3 is opened and the microgrid MG is disconnected from the power system 1. Until the power system 1 is restored, supply of electric power to loads can be continuously performed in the microgrid MG by transmitting and receiving electric power to and from power resources via the power distribution network 2. Alternatively, supply of electric power to loads can also be continuously performed by allowing a mobile object 6 and other power resources to directly transmit and receive electric power via charging/discharging facilities 5 as described above.

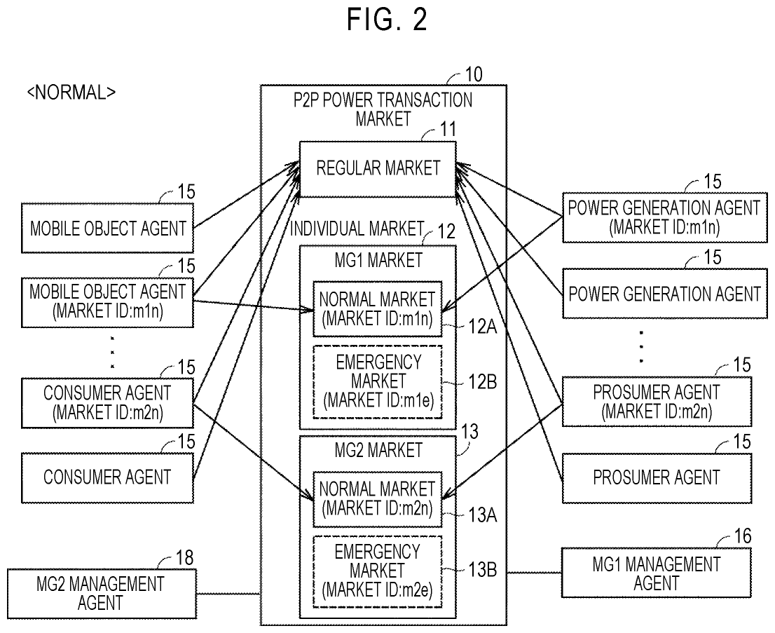

Introduction of peer-to-peer (P2P) power transactions in which electric power is directly traded between a plurality of power resources 4 into the microgrid MG has been considered. FIG. 2 illustrates a system for allowing P2P power transactions between a plurality of power resources 4.

As illustrated in FIG. 2, a plurality of tender agents 15 is present in a P2P power transaction system in the microgrid MG. The plurality of tender agents 15 includes tender agents of power resources 4 in the microgrid MG1 and tender agents of power resources 4 in the microgrid MG2.

The plurality of tender agents 15 includes “power generation agents” that manage tenders and contracts of distributed power supplies, “consumer agents” that manage tenders and contracts of consumers, “prosumer agents” that manage tenders and contracts of prosumers, and “mobile object agents” that manage tenders and contracts of mobile objects 6. Each tender agent 15 is configured to exchange information with a P2P power transaction market 10 via a communication network. Each power resource 4 makes a tender via the corresponding tender agent.

When P2P transactions of electric power are implemented in the microgrid MG, a “regular market” and an “individual market” are considered as a form of a market. The “regular market” is a market in which a contract of electric power supplied from a seller to a purchaser via the power system 1 is made. In the power transmission and distribution system illustrated in FIG. 1, a case in which a power resource 4 in the microgrid MG1 is a seller, a power resource 4 in the microgrid MG2 is a purchaser, and electric power is traded via the power system 1, a case in which a power resource 4 in the microgrid MG2 is a seller, a power resource 4 in the microgrid MG1 is a purchaser, and electric power is traded via the power system 1, and the like are conceived.

The “individual market” is a market in which contracts for transactions of electric power transmitted and received between power resources 4 are made in the individual microgrids MG (hereinafter also referred to as an “MG market”). In the P2P power transaction market 10 illustrated in FIG. 2, an “MG1 market 12” which is an individual market in which contracts for transactions of electric power transmitted and received in the microgrid MG1 are made and an “MG2 market 13” which is an individual market in which contracts for transactions of electric power transmitted and received in the microgrid MG2 are made are open.

Each MG market is managed by an MG management agent. The MG management agent may be configured, for example, as a server that is managed by a management device 7 of a microgrid MG. The MG management agent corresponds to an example of a “management device.”

The MG1 market 12 is managed by an MG1 management agent 16. The MG1 management agent 16 issues identification information for identifying the MG1 market 12 (a market ID) and a password for log-in to the MG1 market 12 and assigns the market ID and the password to the MG1 market 12. The tender agents 15 of the power resources 4 connected to the microgrid MG1 are notified of the market ID and the password of the MG1 market 12. Accordingly, only the power resources 4 connected to the microgrid MG1 can make a tender in the MG1 market 12 via the tender agents 15.

The MG2 market 13 is managed by an MG2 management agent 18. The MG2 management agent 18 issues identification information for identifying the MG2 market 13 (a market ID) and a password for log-in to the MG2 market 13 and assigns the market ID and the password to the MG2 market 13. The tender agents 15 of the power resources 4 connected to the microgrid MG2 are notified of the market ID and the password of the MG2 market 13. Accordingly, only the power resources 4 connected to the microgrid MG2 can make a tender in the MG2 market 13 via the tender agents 15.

In the P2P power transaction system illustrated in FIG. 2, in the normal state of the power system 1, the power resources 4 in the microgrid MG1 can perform transactions of electric power in the regular market 11 and transactions of electric power in the MG1 market 12 via the tender agents 15.

Specifically, in the regular market 11, tenders from arbitrary power resources 4 are received via the tender agents 15, and a contract is made for a tender in which tender conditions of a seller and tender conditions of a purchaser match. Specifically, a plurality of sellers and a plurality of purchasers tender pairs of an amount of electric power and a price for each unit time period. The “unit time period” denotes one time period out of a plurality of time periods obtained by dividing a time in which a transaction of electric power is performed by a predetermined time length set in the P2P power transaction market 1. Currently, since 24 hours is divided into 48 sections in Japan, the length of one unit time period is 30 minutes. A transaction for electric power is performed for an amount of electric power (power×length of unit time period) which is transmitted in the unit time period.

In the individual markets, one MG market is formed for a plurality of power resources 4 connected to one microgrid MG. In the MG1 market 12, one power resource 4 in the microgrid MG1 makes a tender for sale or purchase for each unit time period, another power resource 4 in the microgrid MG1 makes a tender for sale or purchase for each unit time period, and tenders of which conditions match are contracted. A transaction of electric power between the power resources 4 in the microgrid MG1 is realized by at least one of transmitting and receiving electric power via the power distribution network 2 and directly transmitting and receiving electric power via a charging/discharging facility in the power resources 4.

On the other hand, in the emergency state in which supply of electric power from the power system 1 is stopped, electric power in the regular market 11 is not tradable and thus electric power only in the MG1 market 12 is traded. In the microgrid MG1, since consumers are disconnected from the power system 1, each consumer needs to be supplied with electric power from another power resource 4 such as a distributed power supply or a mobile object. Accordingly, a consumer makes a tender for sale in the MG1 market 12. The MG1 market 12 receives a tender for sale from a distributed power supply or a mobile object, and a contract is made for a tender of which conditions match.

In the emergency state of the power system 1, transactions of electric power for which a contract has been made needs to be reliably implemented for the purpose of a balance between supply and demand of electric power in the microgrid MG. This is because, when a seller cannot supply electric power to the partner consumer with which a contract has been made, demand of the consumer cannot be satisfied and there is a likelihood that the balance between supply and demand of electric power will be lost. When the balance between supply and demand of electric power is lost, a system frequency may change, which may cause stopping of the power generation facilities.

In this way, in the emergency state of the power system 1, contracts for the power transactions need to be reliably implemented for the purpose of maintaining the balance between supply and demand of electric power as well as in the normal state of the power system 1. This embodiment provides a structure for prompting a participant, who implements a transaction of electric power in an MG market, to perform reliable implementation of a contract or preparation of a tender plan with implementation reliability. A “participant” is a person who is authorized to perform a transaction of electric power in the MG market, and examples thereof are the plurality of power resources 4 connected to the microgrid MG.

Specifically, as illustrated in FIG. 2, a “normal market” and an “emergency market” are provided in each of the MG markets 12 and 13. In the MG1 market 12, a normal market 12A is a market in which a transaction of electric power in the microgrid MG1 is contracted in the normal state of the power system 1. An emergency market 12B is a market in which a transaction of electric power in the microgrid MG1 is contracted in the emergency state of the power system 1. A market ID and a password different from those of the normal market 12A can be assigned to the emergency market 12B. The normal market 12A corresponds to an example of a “first individual market,” and the emergency market 12B corresponds to an example of a “second individual market.”

The P2P power transaction market 10 validates the normal market 12A and invalidates the emergency market 12B in the normal state of the power system 1. On the other hand, in the emergency state of the power system 1, the P2P power transaction market 10 invalidates the normal market 12A and validates the emergency market 12B. Transition from the normal market 12A to the emergency market 12B is performed in response to a request from the MG management agent 16 as will be described later.

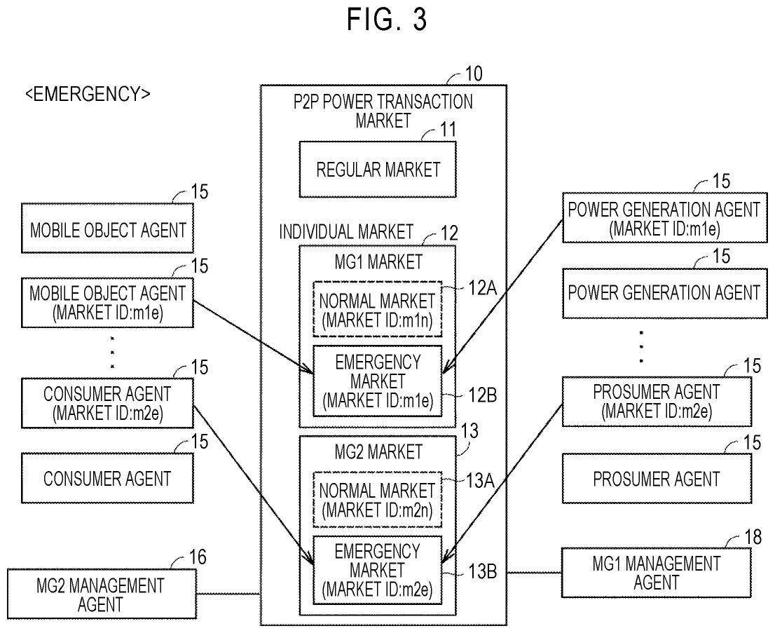

FIG. 2 illustrates the P2P power transaction market 10 in the normal state of the power system 1. In the normal state of the power system 1, the regular market 11 and the normal markets 12A and 13A in the MG markets 12 and 13 are validated. On the other hand, FIG. 3 illustrates the P2P power transaction market 10 in the emergency state of the power system 1. In the emergency state of the power system 1, the emergency markets 12B and 13B in the MG markets 12 and 13 are validated.

In the emergency state of the power system 1, the P2P power transaction market 10 is configured to receive only tenders in the emergency market 12B from a plurality of power resources 4 connected to the microgrid MG1, to contract the received tenders, and not to receive tenders in a market other than the emergency market 12B and/or not to contract tenders in a market other than the emergency market 12B. Similarly, in the emergency state of the power system 1, the P2P power transaction market 10 is configured to receive only tenders in the emergency market 13B from a plurality of power resources 4 connected to the microgrid MG2, to contract the received tenders, and not to receive tenders in a market other than the emergency market 13B and/or not to contract tenders in a market other than the emergency market 13B. The P2P power transaction market 10 can restrict the emergency market in which the power resources 4 can make tenders and contracts based on information indicating to what microgrid MG the power resources 4 are connected.

In the MG1 market 12, the normal market 12A and the emergency market 12B are different in rules in P2P power transactions. The two markets are different in penalties which are imposed on participants who do not implement contracts. In the emergency market 12B, the penalty imposed on a participant who does not implement a contract is set to a higher value than that in the normal market 12A. In the emergency state of the power system 1, a participant is requested to reliably implement a contract by imposing a higher penalty thereon. A participant is requested to prepare a tender plan such that a tender with higher reliability is made.

Configuration of Power Transaction System

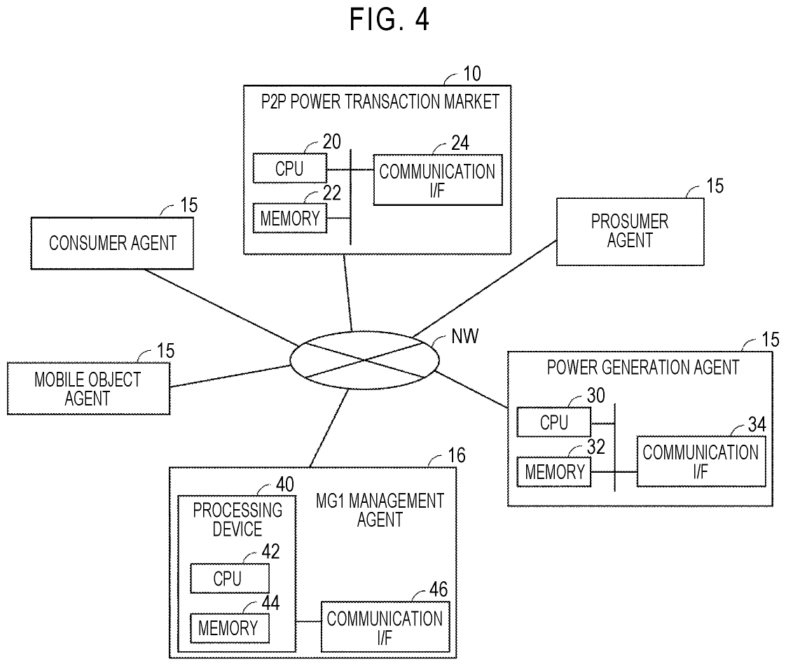

FIG. 4 is a diagram schematically illustrating the entire configuration of the power transaction system according to this embodiment. As illustrated in FIG. 4, the power transaction system includes a P2P power transaction market 10, a plurality of tender agents 15, and an MG1 management agent 16. The P2P power transaction market 10, the plurality of tender agents 15, and the MG1 management agent 16 are communicatively connected to each other via a communication network NW. The plurality of tender agents 15 illustrated in FIG. 4 manages tenders and contracts of a plurality of power resources 4 in the microgrid MG1. In FIG. 4, the power resources 4, the tender agents 15, and the MG2 management agent 18 in the microgrid MG2 are not illustrated.

The P2P power transaction market 10 is an information processing device that performs P2P power transactions. The P2P power transaction market 10 includes a processor 20, a memory 22, and a communication interface (I/F) 24. The processor 20 is, for example, a central processing unit (CPU) and is configured to perform predetermined arithmetic processes described in a program. These arithmetic processes include tenders and contracts from the tender agents 15. The memory 22 includes a read only memory (ROM) and a random access memory (RAM). The ROM stores a program which is executed by the processor 20. The RAM temporarily stores data generated through execution of a program in the processor and data input via the communication I/F 24. The RAM also serves as a temporary data memory which is used as a work area.

The communication I/F 24 is configured to interactively communicate with an external device (such as the tender agents 15 and the MG management agents 16 and 18) of the P2P power transaction market 10 via the communication network NW. The P2P power transaction market 10 may be configured using a computer device which is provided in an operator of the P2P power transaction market 10 or may be configured using cloud computing.

Each tender agent 15 is an information processing device that manages a tender and a contract of the corresponding power resource 4. The tender agent 15 includes a processor 30, a memory 32, and a communication I/F 34. The processor 30 is, for example, a CPU and is configured to perform predetermined arithmetic processes described in a program. These arithmetic processes include tenders for power transactions in the P2P power transaction market. The memory 32 includes a ROM and a RAM. The ROM stores a program which is executed by the processor 30. The RAM temporarily stores data generated through execution of a program in the processor 30 and data input via the communication I/F 34. The RAM also serves as a temporary data memory which is used as a work area.

The communication I/F 34 is configured to interactively communicate with an external device (such as the P2P power transaction market 10 and the MG management agent 16) of the tender agent 15 via the communication network NW. The tender agent 15 may be configured using a computer device which is provided in a power resource or may be configured using cloud computing.

The MG1 management agent 16 is an information processing device that manages transactions of electric power in the MG1 market 12. The MG1 management agent 16 includes a processing device 40 and a communication I/F 46. The processing device 40 includes a processor 42 and a memory 44. The processor 42 is, for example, a CPU and is configured to perform predetermined arithmetic processes described in a program. These arithmetic processes include a request for switching to an emergency market 12B for the P2P power transaction market 10.

The memory 44 includes a ROM and a RAM. The ROM stores a program which is executed by the processor 42. The RAM temporarily stores data generated through execution of a program in the processor 42 and data input via the communication I/F 46. The RAM also serves as a temporary data memory which is used as a work area.

The communication I/F 46 is configured to interactively communicate with an external device (such as the P2P power transaction market 10 and the tender agents 15) of the MG1 management agent 16 via the communication network NW. The MG1 management agent 16 may be configured using a computer device which is provided in the management device 7 of the microgrid MG1 or may be configured using cloud computing.

Transitioning Process in MG Market

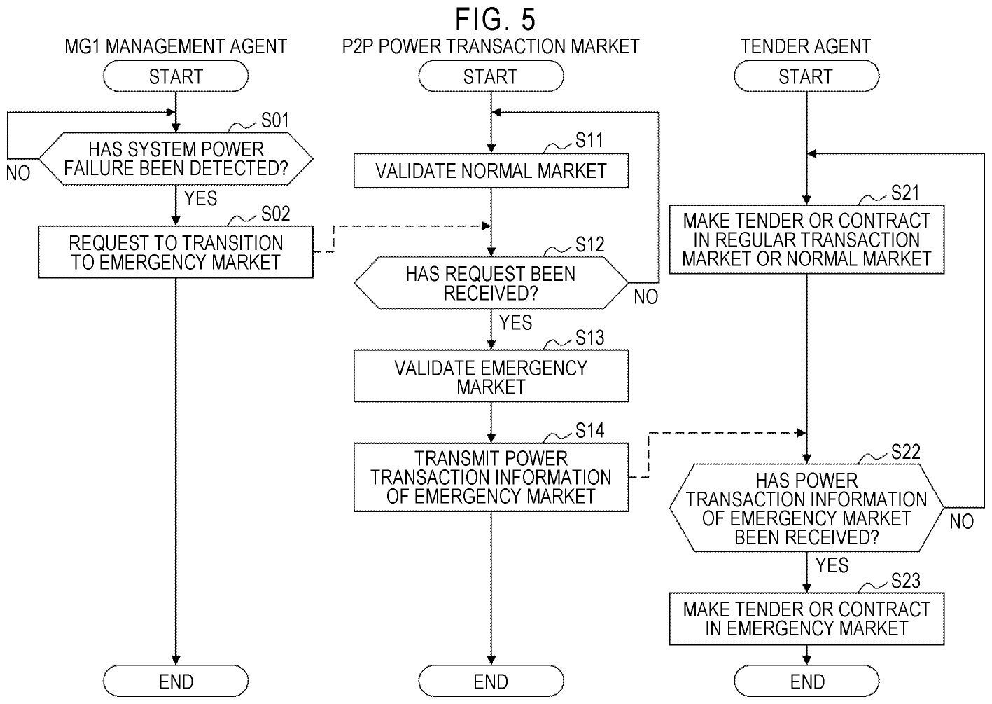

A routine of transitioning from the normal market 12A to the emergency market 12B in the MG1 market 12 will be described below with reference to FIGS. 5 and 6.

FIG. 5 is a flowchart illustrating a routine of transitioning from the normal market 12A to the emergency market 12B. In the drawing, a routine performed by the processing device 40 of the MG1 management agent 16 is illustrated in the left part, a routine performed by the processor 20 of the P2P power transaction market 10 is illustrated in the central part, and a routine performed by the processor 30 of the tender agent 15 is illustrated in the right part. The steps are realized by software processes which are performed by the processor the processing device 40 and the processors 30 and 42, and may be realized by hardware such as large scale integration (LSI) mounted in the processing device 40 and the processors 30 and 42.

First, the MG1 management agent 16 determines whether a power failure of the power system 1 has occurred in Step (hereinafter simply abbreviated to S) 01. In S01, for example, the management device 7 of the microgrid MG1 can detect a voltage of the power system 1 and detect a power failure of the power system 1 when a detected value is less than a predetermined threshold value.

When a power failure of the power system 1 has been detected (S01: YES), the MG1 management agent 16 outputs a request for transitioning from the normal market 12A to the emergency market 12B in the MG1 market 12 to the P2P power transaction market 10 via the communication network NW in S02.

In the normal state in which a power failure of the power system 1 does not occur, the P2P power transaction market 10 validates the normal market 12A in the MG1 market 12 and invalidates the emergency market 12B in S11. In S12, the P2P power transaction market 10 determines whether a request for transitioning to the emergency market 12B has been received from the MG1 management agent 16. When the request has not been received, the routine returns to S11 and validation of the normal market 12A is maintained.

When a request from the MG1 management agent 16 has been received (S12: YES), the routine proceeds to S13, and the P2P power transaction market 10 causes the MG1 market 12 to transition from the normal market 12A to the emergency market 12B by invalidating the normal market 12A in the MG1 market 12 and validating the emergency market 12B.

In S14, the P2P power transaction market 10 transmits information on power transactions in the emergency market 12B to a tender agent 15 that can make a tender in the MG1 market 12 via the communication network NW. This information on power transactions includes a market ID and a password of the emergency market 12B and rules in the power transactions in the emergency market 12B. The information on power transactions includes information on penalties.

After the MG1 market 12 has transitioned to the emergency market 12B, the P2P power transaction market 10 receives tenders from only the power resources 4 in the emergency market 12B connected to the microgrid MG1 and makes a contract. That is, the P2P power transaction market 10 is configured not to receive tenders in the emergency market 12B from the power resources 4 connected to another microgrid MG and/or not to make a contract for the tenders.

In the normal state of the power system 1, the tender agent 15 makes a tender for sale or purchase of electric power in the regular market 11 or the normal market 12A of the MG1 market 12 in S21 (see FIG. 2). As described above, the tender agent 15 makes a tender for sale or purchase for each unit time period. In the regular market 11 and the normal market 12A, tenders with matching conditions are contracted.

In S22, the tender agent 15 determines whether information on a power transaction in the emergency market 12B has been received from the P2P power transaction market 10. When the information has not been received (S22: NO), the routine returns to S21 and a tender in the regular market 11 or the normal market 12A is made.

On the other hand, when information on a power transaction in the emergency market 12B has been received (S22: NO), the tender agent 15 logs in to the emergency market 12B using the market ID and the password included in the received information. In the emergency market 12B, the tender agent 15 makes a tender for sale or purchase for each unit time period and contracts a tender with matching conditions.

In the flowchart illustrated in FIG. 5, when a power failure of the power system 1 has occurred, the MG1 market 12 in the P2P power transaction market 10 transitions from the normal market 12A to the emergency market 12B. The tender agent 15 of the power resource 4 connected to the microgrid MG1 makes a tender and a contract in the emergency market 12B according to the rules for power transactions in the emergency market 12B.

However, when communication between the MG1 management agent 16 and the P2P power transaction market 10 has not been established, the MG1 management agent 16 cannot transmit a request for transitioning to the emergency market 12B to the P2P power transaction market 10. FIG. 6 illustrates a routine of transitioning from the normal market 12A to the emergency market 12B when communication between the MG1 management agent 16 and the P2P power transaction market 10 has not been established. In the flowchart illustrated in FIG. 6, the processes of S03 to S05 are added to the flowchart illustrated in FIG. 5.

First, in S01 which is the same as in FIG. 5, the MG1 management agent 16 determines whether a power failure of the power system 1 has occurred. When a power failure of the power system 1 has been detected (S01: YES), the MG1 management agent 16 determines whether communication between the MG1 management agent 16 and the P2P power transaction market 10 has been established in S03. In S03, it can be determined that the communication has been established, for example, when the MG1 management agent 16 transmits a request for starting communication to the P2P power transaction market 10 and receives a response to the request from the P2P power transaction market 10.

When it is determined in S03 that communication between the MG1 management agent 16 and the P2P power transaction market 10 has been established (S03: YES), the MG1 management agent 16 outputs a request for transitioning from the normal market 12A in the MG1 market 12 to the emergency market 12B to the P2P power transaction market 10 via the communication network NW in S02 which is the same as in FIG. 5. The P2P power transaction market 10 having received the request performs the processes of S12 to S14 which are the same as in FIG. 5.

On the other hand, when it is determined in S03 that communication between the MG1 management agent 16 and the P2P power transaction market 10 has not been established (S03: NO), the MG1 management agent 16 opens an emergency market which is independent from the P2P power transaction market 10 in S04. This emergency market has the same function as the emergency market 12B in the P2P power transaction market 10. The MG1 management agent 16 can open an emergency market in a server which is managed by itself. Accordingly, in the emergency state of the power system 1, it is possible to prevent a transaction of electric power between the power resources 4 from becoming impossible due to a communication abnormality between the P2P power transaction market 10 and the MG1 management agent 16.

In S05, the MG1 management agent 16 transmits information on power transactions in the emergency market 12B to a tender agent 15 that can make a tender in the MG1 market 12 via the communication network NW. This information on power transactions includes a market ID and a password of the emergency market 12B and rules (such as penalty information) in the power transactions in the emergency market 12B.

In the normal state of the power system 1, the tender agent 15 makes a tender for sale or purchase of electric power in the regular market 11 or the normal market 12A in S21 which is the same as in FIG. 5. In S22, the tender agent 15 determines whether information on power transactions in the emergency market 12B has been received from the P2P power transaction market 10 or the MG1 management agent 16. When the information has not been received (S22: NO), the routine returns to S21 and a tender in the regular market 11 or the normal market 12A is made.

On the other hand, when information on power transactions in the emergency market 12B has been received (S22: YES), the tender agent 15 logs in to the emergency market 12B using the market ID and the password included in the information. In the emergency market 12B, the tender agent makes a tender for sale or purchase for each unit time period and contracts a tender with matching conditions.

Penalty in MG Market

A penalty which is imposed on a participant who does not implement a contract in the MG market will be described below.

As will be described below, the penalty can be set based on one of (1) an attainment level of a participant in a power transaction, (2) an urgency level of electric power of a purchaser in a power transaction, and (3) a route of a power transaction or a combination of two or more thereof.

(1) Attainment Level of Participant in Power Transaction

Specifically, the penalty can be set based on an attainment level of a participant. The “attainment level of a participant” indicates a level at which a participant has attained a power transaction which is expected for the participant. The MG management agent can calculate an attainment level based on transaction results for each participant.

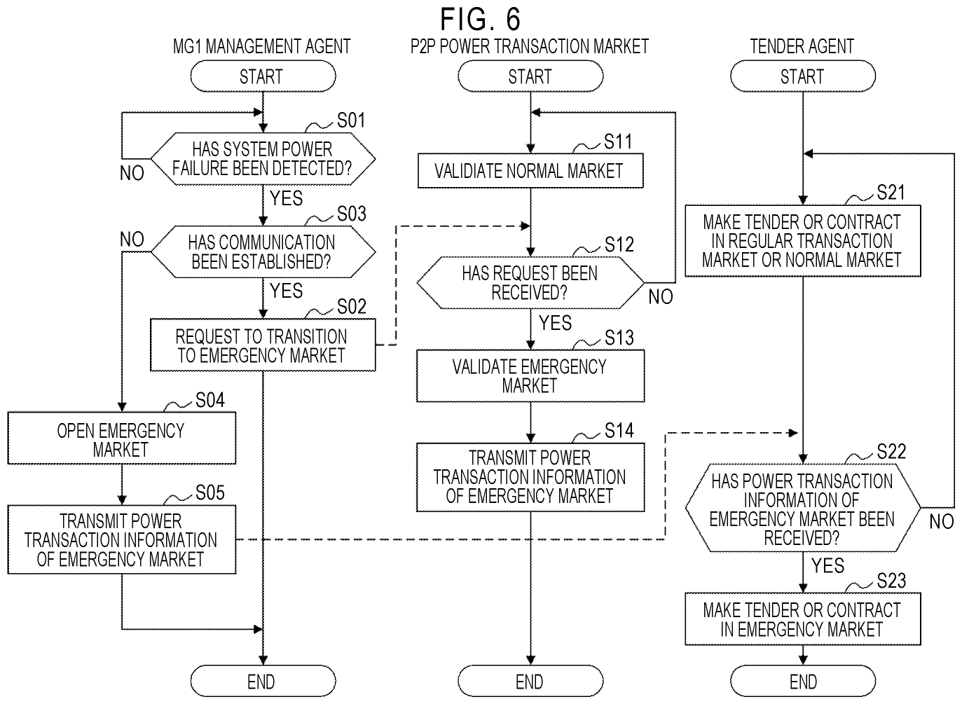

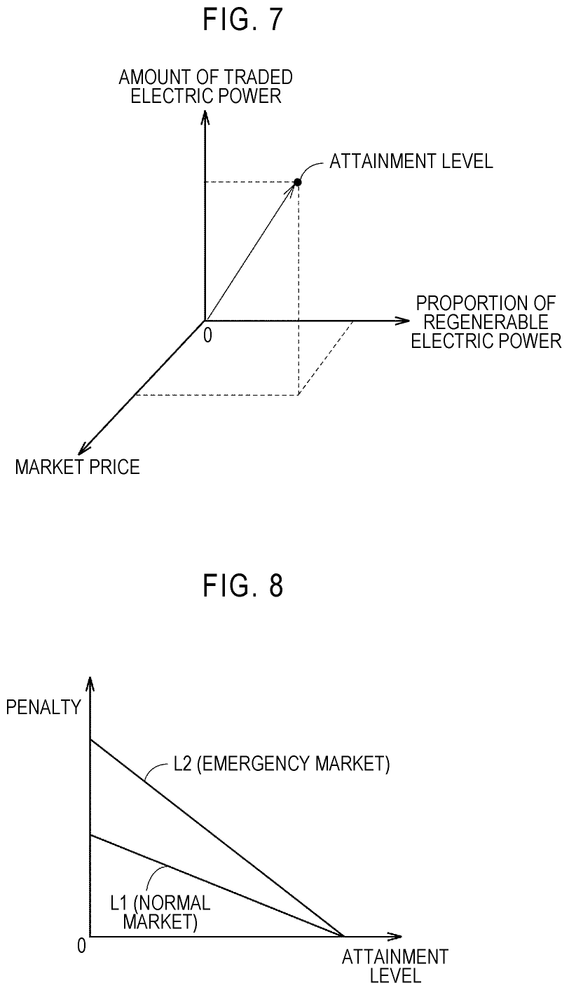

FIG. 7 is a diagram illustrating an example of a method of calculating an attainment level. As illustrated in FIG. 7, the attainment level can be calculated based on at least one of a result value of an amount of electric power traded by a participant in the MG market, a market price of the amount of electric power traded by the participant for each unit time period, and a proportion of regenerable electric power in the amount of electric power traded by the participant.

Specifically, the attainment level can be calculated based on an amount of electric power to be traded according to a contract by a participant in the MG market and an amount of electric power (a result value) actually traded by the participant. For example, a ratio of the amount of electric power actually traded to the amount of electric power to be traded according to a contract by the participant is calculated. When this ratio is 1 (that is, when the amount of electric power to be traded is equal to the amount of electric power actually traded), the attainment level is maximized. As the ratio decreases from 1, the attainment level is calculated such that it decreases from the maximum value. Accordingly, the attainment level is maximized when a transaction of electric power has been implemented according to a contract, and the attainment level decreases as the ratio of the result value of the amount of electric power to the contracted amount of electric power decreases when the contract has not been implemented.

Alternatively, the attainment level can be calculated based on a market price of the amount of electric power traded by a participant in the MG market for each unit time period. In the microgrid MG, it is predicted that a purchase price tendered in the MG market by a power resource 4 is set to be higher to supply more electric power from the MG market as demand for electric power in the power resource 4 increases. The purchase price of an amount of electric power is a market price when a power resource 4 purchases electric power from another power resource 4. As the market price of an amount of electric power traded increases, the demand for electric power in a power resource 4 is determined to increase and thus the attainment level increases.

Alternatively, the attainment level can be calculated based on a proportion of regenerable electric power occupied in an amount of electric power traded. Regenerable electric power is electric power which is generated using regenerable energy. Regenerable energy is energy which is normally present in a natural system such as a part of earth resources like solar light or wind power and has characteristics that it is not exhausted, is present anywhere, and does not discharge CO₂. Accordingly, it is expected to promote sale and purchase of regenerable electric power in the microgrid MG from a point of view of stable supply of energy and decrease in environmental load. As a result, as the proportion of regenerable electric power occupied in the amount of electric power traded increases, expectation is determined to be more satisfied and thus the attainment level increases.

FIG. 7 illustrates a configuration for calculating the attainment level based on the result value of the amount of electric power traded by a participant in the MG market, the market price of the amount of electric power traded by the participant for each unit time period, and the proportion of regenerable electric power in the amount of electric power traded by the participant. The attainment level can also be calculated based on at least one of the three parameters.

The MG management agent sets a penalty which is imposed on a participant according to the calculated attainment level of the participant. FIG. 8 is a diagram schematically illustrating a relationship between the attainment level and the penalty. The horizontal axis in FIG. 8 represents the attainment level, and the vertical axis represents the penalty. A line L1 in the drawing indicates a relationship between the attainment level and the penalty in a normal market. A line L2 in the drawing indicates a relationship between the attainment level and the penalty in an emergency market.

As illustrated in FIG. 8, the penalty to be imposed on a participant increases as the attainment level of the participant decreases. In FIG. 8, a relational expression between the attainment level and the penalty is indicated by a straight line, but the relational expression between the attainment level and the penalty can be appropriately set by the MG management agent.

In FIG. 8, the penalty in the emergency market with respect to the same attainment level is set to a higher value than the penalty in the normal market. That is, in the emergency market, a penalty which is higher than that in the normal market is imposed on a participant. Accordingly, in the emergency state of the power system, it is possible to prompt a participant who performs a transaction of electric power in the MG market to reliably implement a contract. It is possible to prompt a participant to prepare a tender plan with high implementation reliability.

(2) Urgency Level of Electric Power of Purchaser in Power Transaction

The penalty to be imposed on a participant can be set based on an urgency level of electric power of a purchaser in power transactions.

The urgency level of electric power is an index indicating urgency of demand for electric power on the purchaser side. The urgency level of electric power indicates a magnitude of an amount of electric power demand for each unit time period excessing a maximum value (a reference value) of the amount of electric power supplied from the power system and set in advance by consumers. Information on the maximum value of the amount of electric power supplied from the power system by consumers may be acquired in advance by the consumers or may be estimated from transaction results in the market in the past.

When demand for electric power in the consumers increases and an amount of electric power supplied from the power system approaches a scheduled maximum value (a reference value) or is likely to exceed the maximum value, the consumers try to supply electric power through transactions with other power resources in the MG market as peak cut treatment in order to decrease an amount of electric power supplied from the power system. In this case, since the urgency level of demand in the consumers is high, a partner of a power transaction is requested to reliably implement a contract by setting the penalty to a higher value.

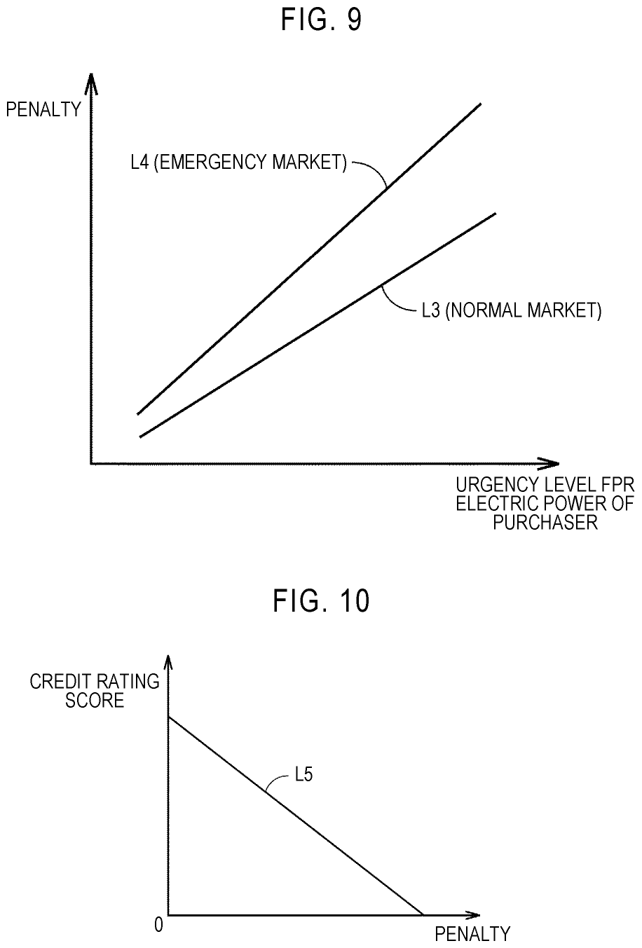

FIG. 9 is a diagram schematically illustrating a relationship between the urgency level of electric power of a purchaser and a penalty. The horizontal axis in FIG. 9 represents the urgency level of electric power of purchasers, and the vertical axis represents the penalty. A line L3 in the drawing indicates a relationship between the urgency level of electric power and the penalty in a normal market. A line L4 in the drawing indicates a relationship between the urgency level of electric power and the penalty in an emergency market.

As illustrated in FIG. 9, the penalty to be imposed on a participant increases as the urgency level of electric power of the purchasers increases. In FIG. 9, a relational expression between the urgency level of electric power and the penalty is indicated by a straight line, but the relational expression between the urgency level of electric power and the penalty can be appropriately set by the MG management agent.

In FIG. 9, the penalty in the emergency market with respect to the same urgency level of electric power is set to a higher value than the penalty in the normal market. That is, in the emergency market, a penalty which is higher than that in the normal market is imposed on a participant. Accordingly, in the emergency state of the power system, supply of electric power from the power system is stopped and thus consumers are supplied with a necessary amount of electric power from only another power resource 4 in the microgrid MG. By setting the penalty to a higher value as the urgency level of electric power in consumers increases, it is possible to reliably achieve supply of electric power in the emergency state of the power system.

(3) Transaction Route of Electric Power

The penalty to be imposed on a participant can be set based on a supply path of electric power from a power resource of a seller to a power resource of a purchaser.

As described above, a transaction of electric power between the power resources 4 in the microgrid MG is realized by at least one of transmitting and receiving electric power via the power distribution network 2 and directly transmitting and receiving via the charging/discharging facilities 5 in the power resources 4.

When electric power is traded via the power distribution network 2, electric power is transmitted via the power distribution network 2 and thus an influence of nonfulfillment of a contract on the balance between supply and demand of electric power in the microgrid MG becomes greater than that in a case in which electric power is directly traded via the charging/discharging facilities 5 in the power resources 4. Accordingly, when electric power is traded via the power distribution network 2, a participant is requested to more reliably implement a contract in comparison with a case in which electric power is directly traded via the charging/discharging facilities 5 in the power resources 4.

Therefore, when electric power is traded via the power distribution network 2, the penalty is set to a higher value in comparison with a case in which electric power is directly traded via the charging/discharging facilities 5 in the power resources 4. Regarding the same transmission path of electric power between the power resources 4, the penalty in the emergency market is set to a higher value than the penalty in the normal market. This is because an influence of nonfulfillment of a contract on the balance between supply and demand of electric power in the microgrid MG in the emergency state of the power system 1 is predicted to be greater than that in the normal state of the power system.

Participant Information

As described above, a penalty is imposed on a participant who does not implement a contract in the MG market. The penalty is based on an actual transaction result of a participant and thus can serve as an index indicating a credit rating level in a power transaction of the participant.

Therefore, the MG management agent calculates an index indicating a credit rating level (hereinafter also referred to as a “credit rating score”) in a power transaction of a participant based on the penalty in each of the normal market and the emergency market and publishes the calculated credit rating score as information on the participant in the MG market.

FIG. 10 is a diagram schematically illustrating a relationship between a credit rating score of a power resource and a penalty. The horizontal axis in FIG. 10 represents the penalty, and the vertical axis represents the credit rating score. A line L5 in the drawing indicates a relationship between the credit rating level of the power resource and the penalty.

As illustrated in FIG. 10, as the penalty imposed on the power resource 4 increases, the credit rating score decreases. In FIG. 10, a relational expression between the credit rating score and the penalty is indicated by a straight line, but the relational expression between the credit rating score and the penalty can be appropriately set by the MG management agent.

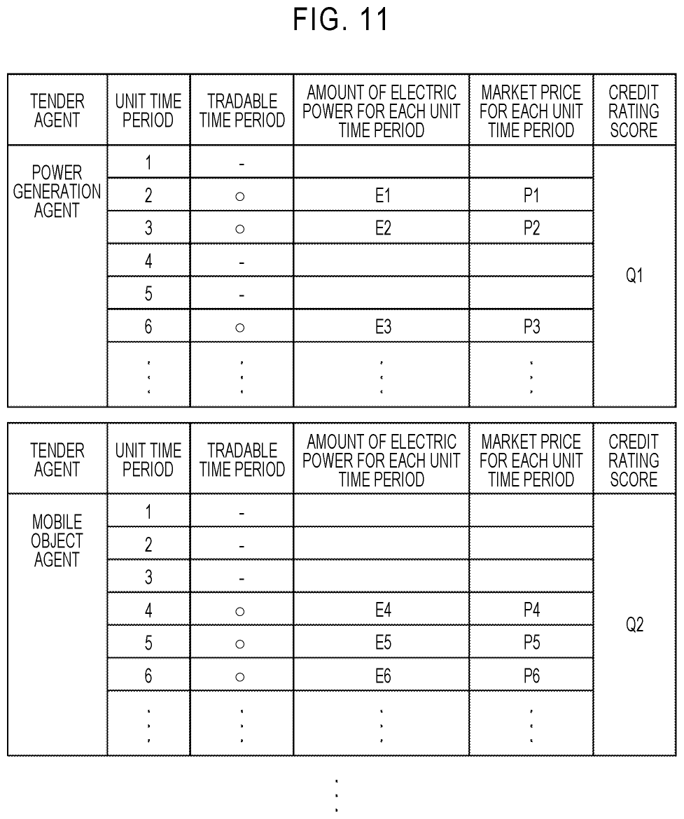

FIG. 11 is a diagram illustrating an example of participant information published in an MG market. As illustrated in FIG. 11, the participant information (a credit rating score) can be included, for example, in tender conditions under which the power resources 4 trade electric power in the MG market.

The tender conditions includes a “time period in which transactions of electric power (in power resources) are possible,” an “amount of electric power for each unit time period in the time period,” and a “market price for each unit time period.” The “time period in which a transaction of electric power is possible” corresponds to a time period in which transmission or reception of electric power to or from a power resource 4 is possible. In FIG. 11, whether electric power can be transmitted or received is shown for each unit time period. Specifically, “o” indicates that electric power can be transmitted or received by the power resources 4, and “-” indicates that electric power cannot be transmitted or received by the power resources 4. The “amount of electric power for each unit time period” is an amount of electric power which can be transmitted or received by a power resource for each unit time period. In a unit time period in which electric power can be supplied from the power resources, a power resource 4 can make a tender for sale of electric power in the MG market. On the other hand, in a unit time period in which electric power can be received by the power resources 4, a power resource can make a tender for purchase of electric power in the MG market. The “market price for each unit time period” is a price for selling or purchasing an amount of electric power for each unit time period.

Referring to FIG. 11, a tender agent 15 can make a contract with reference to the credit rating score of another power resource 4 in addition to tender conditions of the power resource 4. Accordingly, it is possible to promote transactions of electric power between the power resources with high credit rating scores and thus to reduce nonfulfillment of contracts.

The aforementioned embodiment of the present disclosure is only exemplary but not restrictive in all respects. The scope of the present disclosure is defined by the appended claims, not by the aforementioned description of the embodiment, and is intended to include all modifications within the meanings and scope equivalent to the scope of the claims.

What is claimed is:

1. A power transaction system that implements a transaction of electric power in a power distribution network connected to a power system,
wherein a plurality of power resources is connected to the power distribution network, and each of the plurality of power resources is configured to perform at least one of transmitting and receiving electric power to and from another power resource via the power distribution network and directly transmitting and receiving electric power to and from another power resource via a charging/discharging facility owned by the corresponding power resource,
wherein the power transaction system includes:
a power transaction market in which a peer-to-peer transaction of electric power is implemented; and
a management device configured to manage transactions of electric power between the plurality of power resources,
wherein the power transaction market includes:
a first individual market configured to implement transactions of electric power between the plurality of power resources in a normal state of the power system; and
a second individual market configured to implement transactions of electric power between the plurality of power resources in an emergency state in which supply of electric power from the power system is stopped,
wherein the management device is configured to impose a penalty on a participant who does not implement a contract for a transaction of electric power in each of the first and second individual markets, and
wherein the management device is configured to set the penalty in the second individual market to a higher value than the penalty in the first individual market.

2. The power transaction system according to claim 1, wherein the power transaction market is configured to transition from the first individual market to the second individual market and to notify the participant that the penalty has changed with transitioning to the second individual market when occurrence of a power failure in the power system has been detected.

3. The power transaction system according to claim 2, wherein the power transaction market is configured not to accept a tender of the participant in a market other than the second individual market which is open in the power distribution network connected to the participant or not to make a contract for the tender when occurrence of a power failure in the power system has been detected.

4. The power transaction system according to claim 1, wherein the management device is configured to calculate an attainment level based on transaction results of the participant in each of the first and second individual markets and to increase the penalty imposed on the participant as the calculated attainment level decreases, and
wherein the management device is configured to set the penalty in the second individual market for an attainment level to a higher value than the penalty in the first individual market for the same attainment level.

5. The power transaction system according to claim 4, wherein the management device is configured to calculate the attainment level of the participant based on an amount of electric power to be traded by the participant according to the contract and an amount of electric power traded by the participant.

6. The power transaction system according to claim 4, wherein the management device is configured to calculate the attainment level of the participant based on a market price of an amount of electric power traded by the participant.

7. The power transaction system according to claim 4, wherein the management device is configured to calculate the attainment level of the participant based on a proportion of regenerable electric power in an amount of electric power traded by the participant.

8. The power transaction system according to claim 1, wherein the management device is configured to set the penalty in a transaction of electric power transmitted and received via the power distribution network in each of the first and second individual markets to a higher value than the penalty in a transaction of electric power transmitted and received via the charging/discharging facility.

9. The power transaction system according to claim 1, wherein the management device is configured to increase the penalty imposed on a seller who does not implement the contract as an urgency level of electric power for a purchaser increases in each of the first and second individual market, and
wherein the management device is configured to set the penalty in the second individual market for an urgency level to a higher value than the penalty in the first individual market for the same urgency level.

10. The power transaction system according to claim 2, wherein the management device is configured to output a request for transitioning from the first individual market to the second individual market in the power transaction market via a communication network when occurrence of a power failure in the power system has been detected,
wherein the power transaction market is configured to invalidate the first individual market and to validate the second individual market in response to the request from the management device, and
wherein the management device is configured to open a third individual market having the same function as the second individual market independently from the power transaction market and to manage transactions of electric power in the third individual market when communication with the power transaction market has not been established.

11. The power transaction system according to claim 1, wherein the management device includes a power adjustment resource connected to the power distribution network, and
wherein the management device is configured to control the power adjustment resource such that electric power is supplied to the power distribution network when an amount of electric power supplied to the power distribution network is insufficient in the emergency state of the power system.

12. The power transaction system according to claim 1, wherein the management device is configured to calculate an index indicating a credit rating level in a transaction of electric power of the participant in each of the first and second individual markets and to generate participant information using the calculated index, and
wherein the management device is configured to decrease the index as the penalty imposed on the participant increases.

13. A power transaction system that implements a transaction of electric power in a power distribution network connected to a power system,
wherein a plurality of power resources is connected to the power distribution network, and each of the plurality of power resources is configured to perform at least one of transmitting and receiving electric power to and from another power resource via the power distribution network and directly transmitting and receiving electric power to and from another power resource via a charging/discharging facility owned by the corresponding power resource,
wherein the power transaction system includes:
a power transaction market in which a peer-to-peer transaction of electric power is implemented; and
a management device configured to manage transactions of electric power between the plurality of power resources,
wherein the management device is configured to impose a penalty on a participant who does not implement a contract for a transaction of electric power in the power transaction market and to calculate an index indicating a credit rating level in a transaction of electric power of the participant based on the penalty imposed on the participant for each participant, and
wherein the management device is configured to decrease the index as the penalty imposed on the participant increases.
